(19) United States
(12) Patent Application Publication
(10) Pub. No.: US 2010/0042660 A1
(43) Pub. Date: Feb. 18, 2010

(54) SYSTEMS AND METHODS FOR PRESENTING ALTERNATIVE VERSIONS OF USER-SUBMITTED CONTENT

(76) Inventors: Peter Rinearson, Vashon, WA (US); Wistar Rinearson, Redmond, WA (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/539,511

(22) Filed: Aug. 11, 2009

Related U.S. Application Data
(60) Provisional application No. 61/088,307, filed on Aug. 12, 2008.

(51) Int. Cl. G06F 17/30

(52) U.S. Cl. 707/203; 707/E17.116

(57) ABSTRACT

A user-contributor may submit a plurality of related content items and associated metadata to a website corpus. One of the items may be designated as the primary version, and the rest may be designated as secondary versions. The metadata may be associated with the primary version in the website corpus, and, as such, may act as a representative for the secondary versions. An interface may display the primary version in connection with indications of the secondary versions. Ratings of the primary version may be used to determine an overall user rating of the submitter, whereas ratings of the secondary versions may not. Similarly, only the primary version may count against a submission limit of the user and/or be eligible for selection as representative content of the submitter.

### CROSS-REFERENCE TO RELATED APPLICATIONS

This application claims the benefit of U.S. Provisional Application No. 61/088,307, filed Aug. 12, 2008, which is fully incorporated here by reference.

### TECHNICAL FIELD

This disclosure relates generally to systems and methods for presenting alternative views of a user-submitted content item.

### SUMMARY OF THE INVENTION

A user may submit a plurality of related content items to a website corpus, the website corpus comprising a plurality of content items. One of the related content items may be designated as a primary version and the rest may be designated as secondary versions. User-submitted metadata describing the primary versions and the one or more secondary versions may be received. The metadata may be associated with the primary version. Therefore, the primary version may act as a class representative of the other, related content items. The metadata may be used to index the primary version within the corpus to provide for searching, browsing, and the like.

The metadata assigned to the related content items may describe each of the primary and secondary versions. Therefore, the metadata may define which items may be properly included as a related version (e.g., be included as a secondary version of the primary content item). If a content item is accurately described by the metadata, the item may be included; otherwise, the content item should not be included.

The metadata assigned to a group of related content items may be used to index the primary version. Therefore, a search query matching the metadata may return the primary version. In some embodiments, only the primary version may be indexed and/or made available for searching using the user-submitted metadata. Similarly, when browsing the website corpus, only the primary versions may be available. This may avoid cluttering the corpus with plural, similar versions.

A display interface may be provided to display the primary version. The display may include indicators of one or more of the secondary versions and/or may be configured to display the secondary versions along with primary version. The display may include an input to receive a user-submitted rating of the primary version. The secondary versions may not have respective rating inputs. A rating of the primary version may be incorporated into the user rating of the submitter.

In some embodiments, the one or more indicators of the secondary versions may include respective rating inputs. User-submitted ratings received via the one or more secondary rating inputs may not be incorporated into the user rating of the submitter.

The one or more indicators of the secondary versions may comprise links to the secondary versions which, when selected, may cause the secondary versions to be displayed. The links may not be active (e.g., may not cause the secondary versions to be displayed) until a rating of the primary version has been submitted.

The one or more indicators of the secondary versions may be display areas adapted to display one or more of the secondary versions. In some embodiments, the display areas may not display the secondary versions until a rating of the primary version has been submitted.

A user may be permitted to submit only a limited number of content items. The content item that is designated as the primary version may count against this limit. However, in some embodiments, the secondary versions may not be included in the limit.

A user profile may include indicators of representative content submitted by the user. The primary version may be provided for selection as representative content of the user. The secondary versions may be excluded from selection.

### BRIEF DESCRIPTION OF THE DRAWINGS

FIG. 1A is one embodiment of an interface for uploading a primary version and one or more secondary versions of a content item to a website;

FIG. 1B is a flow diagram of one embodiment for providing alternative versions of user-submitted content;

FIGS. 2A and 2B depict embodiments an interface for displaying secondary versions of a user-submitted content item; and

FIG. 3 depicts one embodiment of a system for providing for the display of secondary versions of user-submitted content.

### DETAILED DESCRIPTION OF PREFERRED EMBODIMENTS

Websites and services (collectively websites) featuring user-contributed content have become very popular and are among the fastest growing websites on the Internet. Many of these websites rely on the quality of the content submitted by their users (e.g., the user “community” of the website or service) to attract and retain users. As such, these websites may wish to induce their users to submit high-quality content, or induce them to submit the content in such a way that it is attractive to others.

As used herein, content submitted to a website may be referred to as a “content item” or “item” and may include, but is not limited to: an image, an illustration, a drawing, a pointer, e.g., a link, uniform resource indicator (URI), or the like, a map or location-centric content, video content, Adobe Flash® content, audio content (e.g., a podcast, music, or the like), text content, a game, downloadable content, metadata content, a blog post or entry, a collection and/or arrangement of content items (e.g., into a time-sequence, such as a story or other arrangement), or any other user-authored content. In addition, a content item may include, but is not limited to: a text posting in a threaded or un-threaded discussion or forum, a content item (as defined above) posting in a threaded or un-threaded discussion, a user-submitted message (e.g., forum mail, email, etc.), or the like.

A website may include a corpus of user-submitted content. Accordingly, the corpus may comprise a large number of items, some of which may be related to others. A website may allow users to group related content together. One of the related content items may be designated as the primary version, and the other items may be designated as secondary versions.

The groupings of related content items may be used to simplify searching and/or navigation within the website. For example, when browsing and/or searching within the website corpus, only the primary version may be displayed. A user may select a primary version for viewing (during browsing or searching within the corpus). The viewing interface may include indications of the secondary versions. The indications may display the secondary versions and/or include respective links to allow a user to view the secondary versions.

The related content items may share a common set of metadata. Accordingly, the author of the related content items may apply a single set of metadata to all of the items within the group (as opposed to applying metadata to each related content item individually). The metadata may be associated with the primary version and, as such, the primary version of the content item may act as a “class representative” for the other related content items (e.g., the secondary versions). For example, the primary and secondary versions may share a common title, caption, set of tags, licensing terms, may be related to a similar location and/or timeframe, and the like.

The metadata assigned to the related content items may define which content items may be included as a secondary version. A secondary version may be any content item that is accurately described by the metadata applied to the primary version. For example, if the primary version is a photograph of a basketball game and is associated with metadata related to the game (e.g., metadata that identifies the game, the teams, the location, etc.), secondary versions may include other photographs of the game. Alternatively, if the photograph is of a particular player, and the metadata specifies the particular player (e.g., the metadata identifies the player and the game), the secondary versions may include other photographs of the player in the game, but not photographs of the game generally (e.g., photographs of other players, the venue, etc.).

The primary version may be associated with and/or linked to the secondary versions in the corpus (e.g., in a database, directory, or the like). The association may allow the secondary versions to be accessed from the primary version (e.g., given a particular primary content item, any secondary versions thereof may be identified). As such, a user viewing the primary version may be provided with indications of and/or links to the secondary versions.

In some embodiments, a website may provide various incentives to motivate user-contributors to submit quality work to the website corpus. For example, the website may calculate an overall user rating (user rating) of a user, which may be based upon ratings of content submitted by the user (e.g., ratings submitted by other users, expert reviewers, website employees, or the like). The user rating may be displayed in connection with content and/or posts submitted by the user (e.g., in a user profile). Alternatively, or in addition, indicators of representative content submitted by the user (e.g., representing the “worst” and/or “best” content submitted by the user) may be displayed in connection with the user-contributors activities on the website. Accordingly, other community users may have pervasive access to an easy-to-digest summary of a user's contributions to the website corpus. Users in the community may weigh the contributions and/or commentary of other users based upon the users' contributions to the community as indicated by the user rating and/or representative content. (e.g., the opinion and/or submissions of highly rated users may be given greater weight than those submitted by lower rated users). As such, user-contributors may be motivated to submit only their highest quality works to the website (e.g., to maximize their user rating and/or avoid being associated with poor quality work).

Systems and methods for establishing a user rating and/or a user rating indexes are described in co-pending application No., ______ (attorney docket No. 38938/15), filed Aug. 12, 2009, and entitled, “Systems and Methods for Calculating and Presenting a User-Contributor Rating Index,” which is hereby incorporated by reference in its entirety. Systems and methods for selecting representative content are described in co-pending application No. ______ (attorney docket No. 38938/11), filed Aug. 12, 2009, and entitled, “Systems and Methods for Selecting and Presenting Representative Content of a User,” which is hereby incorporated by reference in its entirety.

In some embodiments, the number of items a user-contributor is allowed to submit to the website corpus may be limited. The limit may prevent the corpus from being overwhelmed with sub-par content. The limit may be fixed for all users and/or may be based upon user ratings or other factors.

The various inducements to encourage quality discussed above may have the undesirable effect of discouraging users from submitting alternative or secondary versions of their content; a user may submit only the “best” item of a set of similar items in order to maximize his/her user rating, to prevent the secondary versions from being selected as representative content, and/or to avoid a submission limit.

The systems and methods disclosed herein may address these disincentives. In some embodiments, only a primary version of a set of related content items may be available for rating by other members of the user community; the secondary versions may not be ratable and/or ratings submitted for the secondary items may not be used to determine the submitters overall user rating. Similarly, in some embodiments, the secondary items may not be available for viewing until after a user has submitted a rating of the corresponding primary version. Other disincentives may be similarly addressed. For instance, the secondary versions may be ineligible for selection as representative content items of the submitter. In embodiments that impose a submission limit on user-contributors, the secondary versions may not count against the limits.

The overall quality of the website corpus may be maintained by limiting access to the secondary versions. As discussed above, only the primary version may be indexed using the metadata associated therewith. As such, only the primary version (and not the plural secondary versions) may be returned from a search. Similarly, in some embodiments, the secondary versions may not be available during general browsing of the website corpus. Instead, the secondary versions may only be accessible if a user first accesses the corresponding primary version. In this way, the website may prevent clutter of the corpus, while making alternative versions of their submitted content available to interested users.

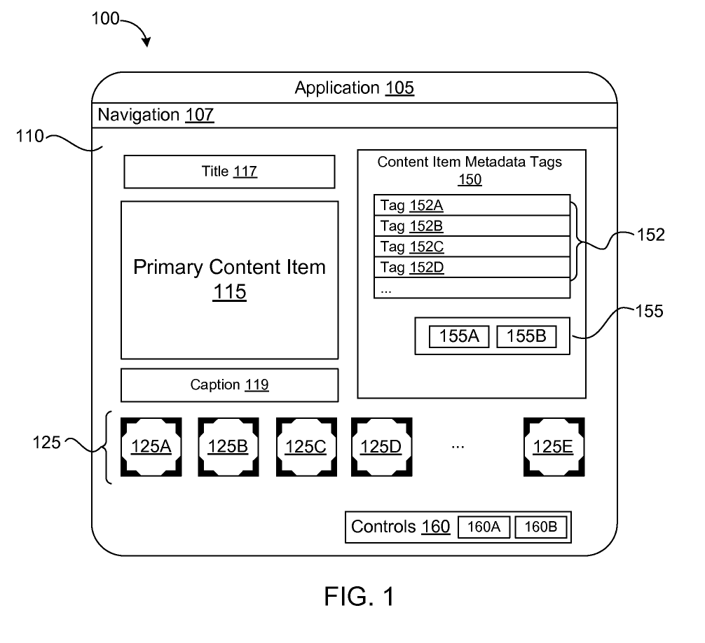

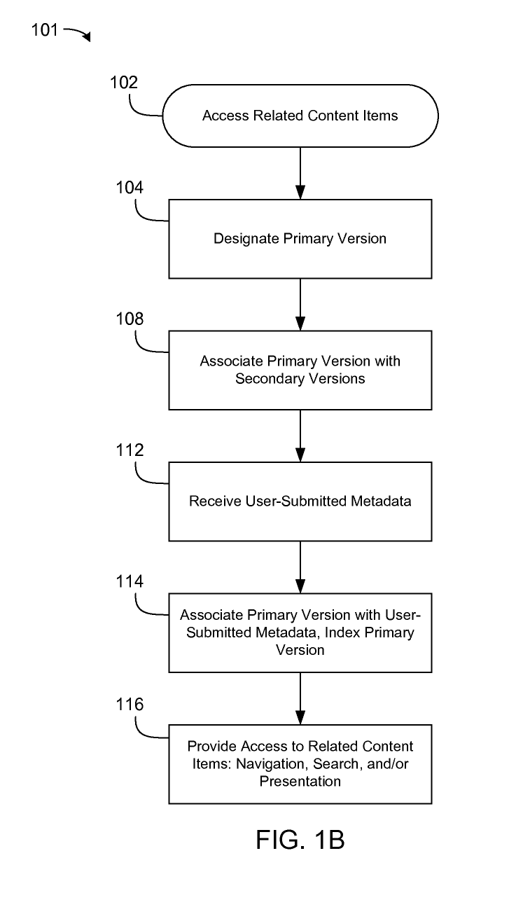

FIG. 1A depicts one embodiment of an interface for uploading a primary content item and one or more secondary content items to a website. The interface 100 may be presented in an application 105, which may comprise a navigation component 107 and a display area 110. The application 105 may comprise web browser software, such as Microsoft Internet Explorer®, Mozilla Firefox®, or Opera®. The application 105 may be configured to display content formatted according to an HTML, Extensible Markup Language (XML), and/or another format (e.g., Flash®, Silverlight®, Portable Document Format (PDF), or the like). Alternatively, the application 105 may be a custom software application designed to display the interface 100.

The navigation component 107 may be used to enter a Uniform Resource Indicator (URI) to access a website and/or to navigate within a website. The website may provide the content submission interface 100 to allow community users to submit content items and/or metadata to the website.

The interface 100 includes controls 160, including an upload or save input 160A, and a cancel input 160B. Selection of the upload input 160A may cause the primary content item 115, one or more related secondary content items 125, the contents of the description input 127, and/or the metadata tags 150 to be uploaded to the website (not shown). When the data is uploaded, it may be included in a website corpus (e.g., stored in a computer-readable storage medium, from which the data may be made available to other users in the community). Selection of the cancel input 160B may clear the interface 100 (e.g., may clear the primary content item 115, secondary content items 125, description input 127, tags 152, and the like).

As discussed above, users may submit content of various different types, including images, video, audio, text, and the like. Therefore, the interface 100 may be adapted to receive and/or display content of various types. The interface 100 may be adapted to receive and/or display images, video, audio, text, interactive content, or the like. Since the secondary versions 125 may be alternative takes of the primary version 115, the primary version 115 and the secondary versions 125 may be the same type of content. For example, if the primary content item 115 is a video, the secondary content items 125 are likely to also be video (e.g., videos having different editing, effects, modified storyline, or the like). Similarly, if the primary content item 115 is a photograph (image), the secondary content items 125 are likely to be alternative takes of the photograph (e.g., taken using different lighting, camera settings, processing, or the like).

The interface 100 may include metadata inputs 117, 119, and/or 150. The title input 117 may allow the submitter to provide a title of the content items (the primary version 115 and the secondary versions 125). A caption input 119 may allow the submitter to provide a short description of the content items 115 and 125. The tag input 150 (discussed below) may allow a user to apply one or more tags to describe and/or categorize the primary 115 and secondary 125 content items. Although a particular set of metadata inputs are depicted in FIG. 1A, the interface is not limited in this regard. Accordingly, the interface 100 could be adapted to provide any number of metadata inputs configured to receive any type of metadata.

As discussed above, the metadata entered via inputs 117, 119, and/or 150 may describe both the primary content item 115 and the secondary content items 125. Accordingly, the metadata may define which items “qualify” as alternative takes (e.g., as secondary items 125). For example, the primary content item 115 may be a photograph of a basketball player participating in a particular game. The title 117 may be “Spartans versus the Bobcats,” and the caption 119 may be, “East Regional Tournament Semi-Finals, Aug. 10, 2007, the Spartans take on the Bobcats.” Since the metadata generally applies to the game, another photo of the game (e.g., including another set of players) may be uploaded as a secondary content item 125. However, if more specific metadata were provided (e.g., titled “Mary Jones plays in the East Regional Tournament.”), only photos of “Mary Jones” would be appropriate as secondary content items 125. Therefore, as the submitter interacts with the interface 100 to enter metadata and/or upload secondary versions 125, the interface 100 may prompt the submitter to verify that proposed changes to the metadata and/or secondary versions are consistent with one another (e.g., with the metadata associated with the primary version 115, the existing secondary content items 125, or the like).

In some embodiments, the interface 100 may include a verification component (e.g., a dialog box, a wizard, or the like) to request verification from the user that a secondary version 125 is consistent with the currently uploaded metadata. If not, the user may be prompted to either modify the metadata and/or to refrain from submitting the non-conforming secondary version. A similar prompt may be provided when uploading metadata through the interface 100. The user may be prompted to verify that the uploaded metadata applies to the primary version 115 and all of the secondary versions 125. If the metadata does not describe all of the versions 115 and/or 125, the user may be prompted to modify or remove the non-conforming metadata and/or remove one or more secondary versions 125.

Selection of the upload input 160A on the controls 160 may cause the primary content item 115, the secondary content items 125A-125E, and metadata entered via the input 117,119, and/or 150 to be transmitted and stored in the website corpus (e.g., on a computer-readable storage medium). As will be discussed below, the primary version 115 may be associated with (e.g., linked to) the secondary versions 125 and the metadata in the corpus.

FIG. 1B is a flow diagram of one embodiment of a method for providing alternative versions of user-submitted content. The method 100 may comprise one or more machine executable instructions stored on a computer-readable storage medium. The instructions may be configured to cause a machine, such as a computing device, to perform the method 100. In some embodiments, the instructions may be embodied as one or more distinct software modules on the storage medium. One or more of the instructions and/or steps of method 100 may interact with one or more hardware components, such as computer-readable storage media, communications interfaces, or the like. Accordingly, one or more of the steps of method 100 may be tied to particular machine components.

At step 102, a set of two or more related content items may be received. The related content items may be received from an interface, such interface 100 described above in conjunction with FIG. 1A; however, alternative interfaces and/or means for submitting content could be used under the teachings of this disclosure.

At step 104, one of the related content items may be designated as a primary version. The designation of the primary version may be made by the submitter of the related content items. The designation of the primary version may cause the rest of the content items received at step 102 to be designated as secondary versions.

At step 108, the primary version may be associated with the secondary versions. The association may be made in a computer-readable storage medium, such as a database, directory, or the like. The associations may include links (e.g., URLs, URIs, or the like) or other identifiers (e.g., primary keys, distinguished names, or the like). The associations may allow the secondary versions to be accessed from the primary version (e.g., the links may be attributes and/or properties of an object representing the primary version).

At step 112, user-submitted metadata may be received. The user-submitted metadata may be provided via an interface, such as the interface 100 described above; however, alternative interfaces could be used. As discussed above, the relationship between the primary version and the secondary versions may be defined by the metadata associated therewith. Accordingly, the metadata may determine whether a particular content item qualifies as an “alternative take” of the primary version. As such, in some embodiments, the receiving step 112 may include verifying with the submitter (e.g., using a prompt or wizard) that the metadata is applicable to the primary version as well as the secondary versions. If not, the user may be prompted to modify the metadata, remove one or more secondary versions, or the like.

At step 114, the metadata may be stored and associated with the primary version in a computer-readable storage medium. The association may include a link or other identifier to allow the user-submitted metadata to be referenced from the primary version and vice versa. Accordingly, the association may comprise one or more links, identifiers, or the like. Alternatively, or in addition, the metadata may be applied as an attribute and/or property of an object representing the primary version on the computer-readable storage medium.

The association of step 114 may further comprise indexing the primary version using the user-submitted metadata. As discussed above, metadata, such as tags, may be used to describe and/or categorize content in the website corpus. The indexing of step 114 may include making the primary version available to one or more search engines and/or categorizers within and/or outside of the corpus (e.g., indexed using an external web crawler, bot, or the like). Only the primary version may be indexed using the user-submitted metadata. Accordingly, only the primary version may be available for selection using the metadata. This may provide for simplified searching, and/or navigation within the website corpus, such that a particular search will only return the primary version, and not any of the high-similar secondary versions associated therewith.

At step 116, the primary version with its associated metadata and secondary versions may be made available within the website corpus, which may comprise making the primary version available for browsing, searching (e.g., indexed using the metadata associated therewith), and/or for presentation to one or more users.

The website corpus may provide the primary version via a content browsing interface. The browsing interface may be configured to provide access to the content items within the corpus. The interface may include category based browsing (e.g., based upon tags applied to the content items), a search (discussed below), or the like (e.g., a listing based upon submission time, author, and so on). The interface may be configured to include only primary versions in the listings. As discussed above, this may prevent the browsing interface from becoming cluttered with highly similar related content items. In some embodiments, list entries for which secondary versions may include an indicia (e.g., overlaid with an icon or other indicator) to inform a user that secondary versions of the content item are available. The secondary versions, however, may not be available and/or visible, unless the user navigates to the primary version (e.g., selects a link to the primary version, or the like).

In some embodiments, the website corpus may be searchable; content items may be indexed and/or categorized using the metadata applied thereto. As discussed above, the primary version may be made available to internal (within the corpus) and/or external search engines. The primary version may be indexed using the metadata received at step 112. A search result may be returned responsive to a search related to the metadata of the primary version. The search result may include the primary version, and omit the secondary versions, which may not be indexed and/or associated with the user-submitted metadata of step 112. As discussed above, a search result comprising the primary version may include indicia to inform the searcher that secondary versions of the content item are available. The secondary versions, however, may not be accessible, unless the searcher navigates to the content item.

Step 116 may further include presenting the primary content item in connection with indicators of the secondary content items. A primary version may be presented responsive to a user selecting a link to the item in a browse and/or search interface as described above. The interface may present the primary version of the content item to the user, and may include indicators of the secondary versions. The indicators may display the secondary versions, may be links to the secondary versions, or the like. In some embodiments, the interface may be configured to concurrently display a primary version with one or more secondary versions.

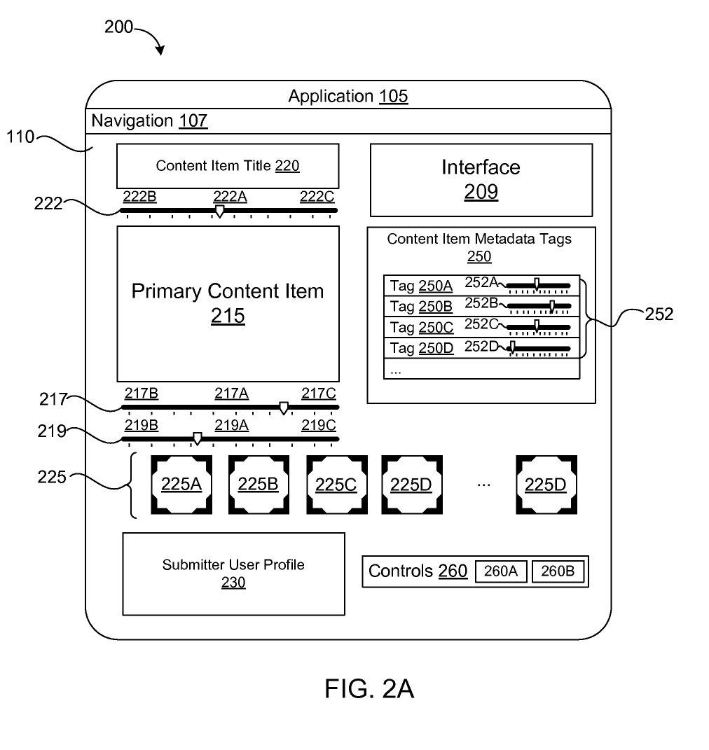

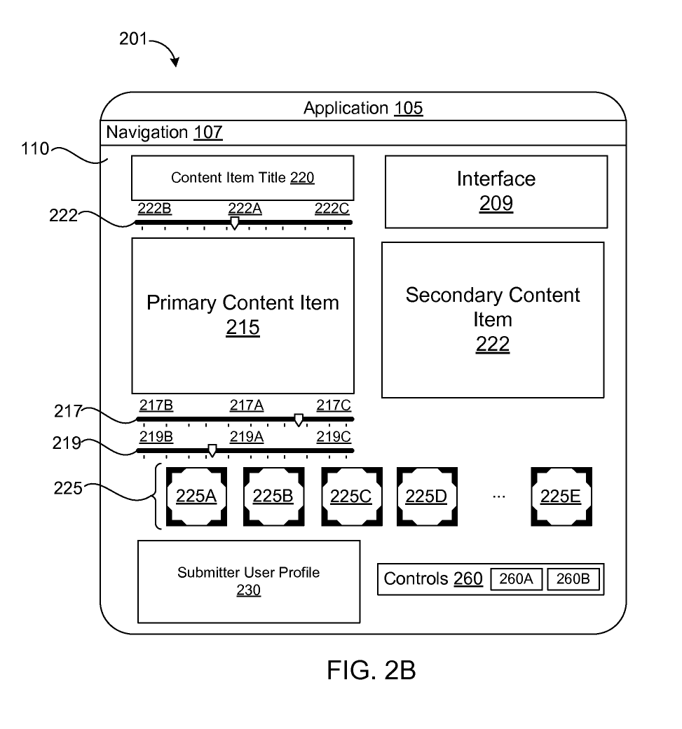

FIG. 2A shows one embodiment of an interface to display a primary content item and one or more related, secondary content items. The interface 200 may be presented in an application 105, which may include a navigation component 107, an interface 209, and a display 110. A navigation interface 209 may be provided to allow a user to navigate the content provided on the website. As such, the navigation interface 209 may comprise a search interface (not shown) or the like. The interface 200 may include a user profile 230, which may display an overall user rating (not shown) and/or representative content of the submitter.

The interface 200 may display metadata describing the primary 215 and secondary versions, such as a title 220, caption (not shown), tags (not shown), and the like. The interface 201 may include inputs 222 and 252 to receive ratings of the metadata 220 and 250.

The interface 200 may be configured to present the primary content item 215 in connection with indications of one or more secondary versions 225. Rating inputs 217, 219, 222, and 252 may be provided to allow users to rate various aspects of the primary content item 215 and/or the metadata associated therewith (e.g., title 220, tags 250, and the like). The rating inputs 217 and 219 may allow a user to submit a rating of one or more aspects or categories of the primary content item 215 (e.g., a subject appeal of the primary content item 215, technical merit of the primary content item 215, and the like). The rating inputs 217 and 219 may each comprise a respective title 217A and 219A, and input through which a rating may be entered (e.g., a low-range indicator 217A, 219B (e.g., “unappealing”) and a respective high-range indicator 217C, 219C (e.g., “appealing”)). The metadata tags 250 (e.g., tags 250A-250D) may include respective rating inputs 252 (e.g., 252A-252D) to allow users to submit ratings of the tags (e.g., rate the relevance of the tags 250).

The interface 200 may comprise controls 260, which may include a save or upload input 260A and a cancel input 260B. The save input 260A may submit the entries provided in the one or more rating inputs 217, 219, 222, and 252 to the website. Selection of the cancel input 260B may clear the rating inputs 217, 219, 222, and 252.

The primary content item 215 may be displayed in connection with indicators 225 of one or more secondary versions. The indications 225 may be adapted to show a reduced resolution view of the secondary items (e.g., a thumbnail image). The indications 225 may be adapted to the type of content displayed therein (e.g., imagery, video, audio, text, etc.).

Although not shown in FIG. 2A, the secondary content item indicators 225 may include respective rating inputs. In some embodiments, the ratings of the secondary content items 225 may not be included in an overall rating of the submitter, and the secondary content items may be excluded from selection as a representative content item of the submitter. Similarly, in some embodiments, the secondary content items may not count against a submission limit of the user-contributor.

In some embodiments, the secondary content item indicators 225 may not be displayed until a rating of the primary content item 215 has been submitted. Alternatively, or in addition, the secondary content item indicators 225 may comprise links or other indicia to show that one or more secondary versions of the primary content item 215 are available. Selection of a link may direct the user to an alternative interface (e.g., interface 201 shown in FIG. 2B) or popup to display the corresponding secondary content item. The links may not be active until a user rating of the primary content item 215 has been submitted.

FIG. 2B shows another embodiment of an interface to display a primary content item in connection with one or more secondary content items. The interface 201 may include secondary content item indicators 225 and/or a secondary content item display area 222. Selection of an indicator 225 may cause the corresponding secondary version to be presented in the secondary version display 222. The indicators 225 and/or the display 222 may be hidden and/or obscured until a rating of the primary content item 215 has been submitted. Although not shown in FIG. 2B, the secondary content item display 222 may include a rating input configured to receive a rating of the secondary content item presented therein. The rating, however, may not be included in calculating an overall user rating of the submitter and/or in selecting representative content.

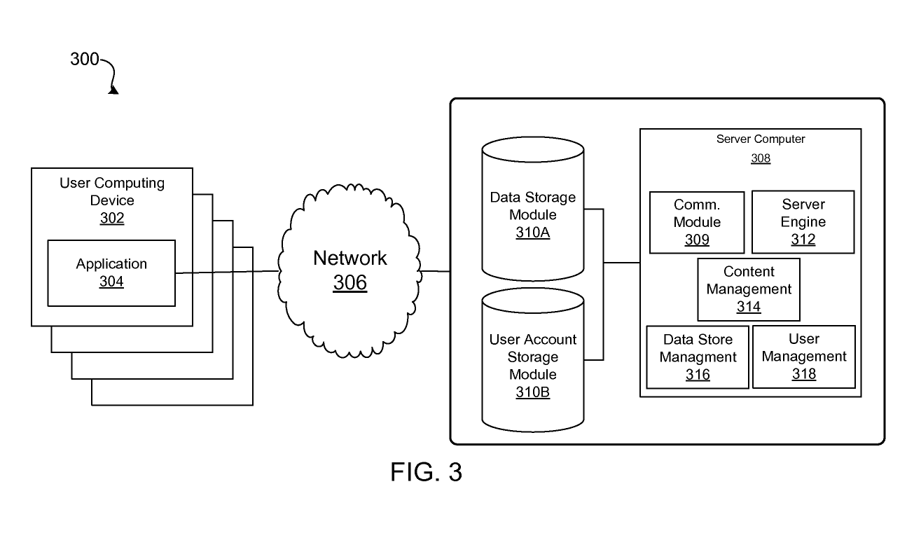

Aspects of the teachings of this disclosure may be practiced in a variety of computing environments. FIG. 3 depicts one embodiment of a system 300 for receiving user-submitted content comprising a primary version and one or more secondary versions and/or for presenting the related content items to a user. The system 300 includes a distributed network of one or more user computing devices 302 communicatively coupled to a server computer 308. The one or more user computing devices 302 may comprise an application 304 that may be used to access and/or exchange data with other computing devices accessible via the network 306, such as a server 308. The application 304 may comprise a web browser, such as Microsoft Internet Explorer®, Mozilla Firefox®, Opera®, or the like. Alternatively, the application 304 may be a media player and/or content presentation software, such as Adobe Creative Suite®, Microsoft Windows Media Player®, Winamp®, or the like. The application 304 may comprise a network interface component to allow the application 304 to access content on the server 308 via the network 306. For example, Adobe Creative Suite® may provide access to a stock photo repository to allow users to purchase content for integration into an Adobe® project; a media player, such as Microsoft Windows Media Player®, may provide access to online, streaming music to allow a user to purchase audio content therefrom; and a web browser may provide access to web accessible content on the network 306.

The application 304 may allow a user to access websites or other content accessible via a Transmission Control Protocol (TCP) Internet Protocol (IP) network (e.g., a TCP/IP network). One such network is the World Wide Web or Internet. One skilled in the art, however, would recognize that the teachings of this disclosure could be practiced using any networking protocol and/or infrastructure. As such, this disclosure should not be read as limited to a TCP/IP network, the Internet, or any other particular networking protocol and/or infrastructure.

The user computing devices 302 may comprise other program modules, such as an operating system, one or more application programs (e.g., word processing or spreadsheet applications), and the like. The user computing devices 302 may be general-purpose and/or specific-purpose devices that may be programmed to run various types of applications, or they may be single-purpose devices optimized or limited to a particular function or class of functions. Alternatively, the user computing devices 302 may comprise a portable computing device, such as a cellular telephone, personal digital assistant (PDA), smart phone, portable media player (e.g., Apple iPod®, multimedia jukebox device), or the like. As such, this disclosure should not be read as limited to any particular user computing device implementation and/or device interface. Accordingly, although several embodiments herein are described in conjunction with a web browser application, the use of a web browser application and a web browser interface are only used as a familiar example. As such, this disclosure should not be read as limited to any particular application implementation and/or interface.

The network 306 may comprise routing, addressing, and storage services to allow computing devices, such as the user computing devices 302 and the server computer 308 to transmit and receive data, such as web pages, text content, audio content, video content, graphic content, and/or multimedia content therebetween. The network 306 may comprise a private network and/or a virtual private network (VPN). The network 306 may comprise a client-server architecture in which a computer, such as the server 308, is dedicated to serving the one or more user computing devices 302, or it may have other architectures, such as a peer-to-peer, in which the one or more user computing devices 302 serve simultaneously as servers and clients. In addition, although FIG. 3 depicts a single server computer 308, one skilled in the art would recognize that multiple server computers 308 could be deployed under the teachings of this disclosure (e.g., in a clustering and/or load sharing configuration). As such, this disclosure should not be read as limited to a single server computer 308.

The server computer 308 may be communicatively coupled to the network 306 by a communication module 309. The communication module 309 may comprise a wired and/or wireless network interface capable of communicating using a networking and/or communication protocol supported by the network 306 and/or the user computing devices 302.

The server 308 may comprise and/or be communicatively coupled to a data storage module 310A. The data storage module 310A may comprise one or more databases, XML data stores, file systems, X.509 directories, LDAP directories, and/or any other data storage and/or retrieval systems known in the art. The data storage module 310A may be implemented using one or more computer-readable storage media, such as hard discs, flash memory, optical storage devices, or the like. The data storage module 310A may comprise web pages and associated content to be transmitted to one or more of user computing devices 302 over network 306 (e.g., the interfaces 200 and/or 201 described above in conjunction with FIGS. 2A and 2B).

The data storage module 310A may be configured to store content items submitted to the server 308. Accordingly, the data storage module 310A may comprise a corpus of content items available on a website. The data storage module 310A may be configured to provide for grouping related content items together. For example, a submitter may designate one of a plurality of related content items as a primary version, and the rest as secondary versions. The designations may be stored in the data storage module 310A, which may be configured to associate or link the primary version to the secondary versions (e.g., using a database reference, such as a primary or foreign key, a URL, or other data referencing technique). Therefore, access to a primary version of a group of related items may also provide access to any of the secondary versions.

The data storage module 310A may be configured to associate metadata with particular content items and/or users. The data storage module 310A may provide for a common metadata repository for a group of content items (e.g., a primary version and one or more secondary versions). The data storage module 310A may be configured to associate metadata of one item in a group (the primary version) with other items in the group (each of the secondary versions) and vice versa. In some embodiments, all metadata of a particular set of related content items (e.g., a primary version and one or more secondary versions), may be associated or linked to the primary version in the data storage module 310A. Accordingly, the primary version may act as a metadata repository for the related content items.

The server computer 308 may comprise a server engine 312, a content page management component 314, and a data storage management module 316. The server engine 312 may perform processing and operating system level tasks including, but not limited to: managing memory access and/or persistent storage systems of server computer 308, managing connections to user computer(s) 302 over network 306, and the like. The server engine 312 may manage connections to/from user computing devices 302 using communication module 309.

The content management module 314 may create, display, and/or otherwise provide content to user computer(s) 302 over network 306. In addition, and as will be discussed below, the content management component 314 may manage content and metadata submitted to the server 308. In addition, the content management component 314 may manage the display of user-submitted content items and metadata to the one or more user computing devices 302. The data storage management module 316 may be configured to interface with the data storage module 310A to store, retrieve, and otherwise manage data in the data storage module 310A.

In some embodiments, the server engine 312 may provide data to the user computing devices 302 according to the HTTP and/or secure HTTP (HTTPS) standards. As such, the server computer 308 may provide web page content to the user computing devices 302. Although the server computer 308 is described as providing data according to the HTTP and/or HTTPS standards, one skilled in the art would recognize that any data transfer protocol and/or standard could be used under the teachings of this disclosure. As such, this disclosure should not be read as limited to any particular data transfer and/or data presentation standard and/or protocol.

The user computing devices 302 may access content stored on the data storage module 310A and made available by a content management module 314 via a URI addressing the server computer 308. The URI may comprise a domain name, which may be resolved by a domain name server (DNS) (not shown) in the network 306 into an IP address. This IP address may allow the user computing devices 302 to address and/or route content requests through the network 306 to the server computer 308. The URI may further comprise a resource identifier to identify a particular content item on the server computer 308 (e.g., content.html).

Responsive to receiving a URI request, the server engine 312 may be configured to provide the content to the user computing device 302 comprising the content (e.g., web page) identified in the URI. The content management module 314 and a data storage management module 316 may be configured to obtain and/or format the requested content to be transmitted to the user computing device 302 by the server engine 312.

Similarly, the server engine 312 may be configured to receive content submitted by a user via the one or more user computing devices 302. The user-submitted content may comprise a content item, such as an image, a video clip, audio content, or any other content item. The user-submitted content may be made available to other users via the one or more user computing devices 302 via the server computer 308. Responsive to a request for a particular content item, the server engine 312 may return a primary version of the content item along with one more secondary (alternative) versions thereof. Accordingly, a searcher may access a set of related content items comprising the primary version and one or more secondary versions in a single search result, as opposed to navigating through a plurality of ungrouped content items.

The content management module 314 may be configured to index and/or categorize the content available on the data storage medium 310A. The categorization may allow for selective browsing of the content (e.g., browse photographs of a particular subject, etc.). The indexing may allow the content to be searched using various queries. In some embodiments, the content management module 314 may be configured to categorize and/or index only the primary versions of a set of related content items. Accordingly, the secondary versions may not be categorized and/or indexed by the content management module 314. Therefore, a user may not be required to navigate through a list and/or set of search results comprising a plurality of highly similar content (e.g., a primary version and set of secondary versions thereof). The content management module 314 may, therefore, associate all user-submitted metadata of a particular set of related content items (e.g., a primary version and one or more secondary versions) with only the primary version.

The content management module 314 may associate the primary version with any related secondary versions in the data storage medium 310A. Therefore, if a user accesses a particular primary version, the secondary versions associated therewith may be easily retrieved. The association may allow for display of the primary version with indications of the secondary versions as shown in FIGS. 2A and 2B.

The server computer 308 may comprise a user management module 318. The user management module 318 may access a user account data storage module 310B. The user account data storage module 310B may comprise one or more user accounts relating to one or more users authorized to access and/or submit content to the server computer 308. The user account data storage module 310B may comprise user profile information. As discussed above, a user profile may comprise a user password, content accessed by the user, content submitted by the user, ratings of the content submitted by the user, rating information submitted by the user, and the like. The user profile may include a user rating, which may be derived from user-submitted ratings of content items submitted by the user. If the user submits a primary version of a content item along with one or more secondary versions, only a rating of the primary version may be included in the overall user rating. In some embodiments, the secondary versions of a content item may not be accessible by a particular user until the particular user submits a rating of the primary version of the content item.

A user profile may further include indicators (e.g., links) to representative content submitted by the user (e.g., a best, worst, and/or typical content item submitted by the user). Secondary or alternative versions may be excluded from selection as a representative item.

A user profile may include a submission limit. The limit may determine the number of content items the user is allowed to submit to the website corpus (e.g., content available on the data storage module 310A). The number of content items submitted by a particular user may be maintained in the user's profile. The limit may be determined by various factors, including, but not limited to: the user's rating, rating distribution, time using the website, payments made by the user to the website, and so on. When submitting a content item to the website, the primary version of a content item may count against the user's submission limit. However, any secondary or alternative versions of the content item may not count against the limit. Alternatively, a secondary limit for the user may be established, which may be used to limit the number of secondary versions the user may submit to the website corpus.

The content management module 314 may be configured to interact with the data store management module 316 and/or the user management module 318 to generate one or more interfaces comprising user-contributed content items and/or user-contributed metadata. The content management module 314 may be configured to generate one or more of the interfaces 100, 200, and/or 201 discussed above to allow a user to upload a primary content item and/or one or more secondary content items, and/or to present a primary content item and/or one or more secondary content items to a user. The server engine 312 may be configured to provide for displaying related content items in a single interface. For example, the server engine 312 may be configured to display a primary version of a content item along with one or more indicators of available secondary content items. The indicators may include links to the secondary versions, views of the secondary versions, or the like. In some embodiments, the secondary versions may not be visible and/or accessible until a user has submitted a rating of the primary version of the content item.

The presentation interfaces may allow website users to rate the primary content item and/or metadata associated with the primary content item. The interfaces may not allow website users to rate the one or more secondary content items. Alternatively, if rating of the secondary content items is permitted, only the rating of the primary version of the content item may be used to calculate the overall user rating of the submitter, establishing the submission limit, and/or selecting representative content for the submitter (e.g., “best,” “worst” and/or “typical” content items).

The server computer 308, including the components thereon (e.g., content manager 314), the data storage module 310A, and the user account data storage module 310B may comprise security measures to inhibit malicious attacks thereon, and to preserve integrity of the messages and data stored therein. Such measures may include, but are not limited to: firewall systems, secure socket layer (SSL) communication, user authentication, public key infrastructure (PKI) authentication, password protection schemes, data encryption, and the like.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

We claim:

1. A computer-readable storage medium comprising instructions to cause a computing device to perform a method for providing secondary versions of a content item submitted by a user to a corpus comprising a plurality of content items, the method comprising:
accessing a plurality of related content items submitted by a user, wherein one of the related content items is designated as a primary version and the rest are designated as secondary versions;
associating the secondary versions with the primary version in the corpus; and
providing a user interface to display the related content items, the user interface comprising a display area to display the primary version and indications of the secondary versions.

2. The computer-readable storage medium of claim 1, further comprising:
receiving user-submitted metadata describing the related content items, wherein the user-submitted metadata is associated with the primary version in the corpus.

3. The computer-readable storage medium of claim 2, wherein the association between the primary version and the user-submitted metadata provides for selection of the primary version using the user-submitted metadata, wherein the secondary versions are not associated with the user-submitted metadata and are not eligible for selection using the metadata.

4. The computer-readable storage medium of claim 2, the method further comprising:
receiving a search query specifying the user-submitted metadata; and
providing a reference to the primary version and not the one or more secondary versions in response to the search query.

5. The computer-readable storage medium of claim 2, wherein the user-submitted metadata specifies a category of the related content items, the method further comprising:
selecting one or more content items from the corpus in the specified category, wherein the primary version is selected and the one or more secondary versions are not eligible for selection.

6. The computer-readable storage medium of claim 2, wherein the user-submitted metadata includes a first tag describing the related content items, the method further comprising:
selecting one or more content items from the corpus having the first tag, wherein the primary version is selected and the one or more secondary versions are not eligible for selection.

7. The computer-readable storage medium of claim 1, wherein the interface includes an input to receive a rating of the primary version, the method further comprising:
receiving a user-submitted rating of the primary version; and
incorporating the user-submitted rating of the primary version into a user rating of the submitter of the related content items.

8. The computer-readable storage medium of claim 7, wherein the one or more indicators of the secondary versions do not include an input to receive a user-submitted rating of the secondary versions.

9. The computer-readable storage medium of claim 7, wherein the one or more indicators of the secondary versions include respective secondary rating inputs, and wherein ratings submitted via the one or more secondary rating inputs are not incorporated into the user rating of the submitter.

10. The computer-readable storage medium of claim 7, wherein the one or more indicators of the secondary versions comprise respective links to the secondary versions which, when selected, cause one or more of the secondary versions to be displayed.

11. The computer-readable storage medium of claim 10, wherein the links are not active until a user-submitted rating of the primary version has been submitted.

12. The computer-readable storage medium of claim 7, wherein the one or more indicators comprise one or more secondary version display areas to display one or more of the secondary versions.

13. The computer-readable storage medium of claim 12, wherein the secondary version display areas do not display the secondary versions until a user-submitted rating of the primary version has been received.

14. The computer-readable storage medium of claim 12, wherein the secondary version display areas display thumbnail images of one or more of the secondary versions.

15. The computer-readable storage medium of claim 1, wherein the submitter of the related content items is permitted to submit only a limited number of content items into the corpus, the method further comprising:
including the primary version in the limited number of content items submitted by the submitter and excluding the secondary versions from the limited number of content items submitted by the submitter.

16. The computer-readable storage medium of claim 1, wherein a user profile of the submitter of the related content items identifies representative content items of the submitter, the method further comprising providing for selection of the primary version as a representative content item of the submitter and excluding the secondary versions from selection as a representative content item submitted by the submitter.

17. A system for providing secondary versions of a content item submitted by a user to a corpus comprising a plurality of content items, comprising:
a computing device comprising a processor,
computer readable storage medium comprising the corpus, the corpus including a plurality of related content items received from a submitter, wherein one of the content items is designated as a primary version and the rest are designated as secondary versions;
a communication module operable on the processor and communicatively coupled to the computer readable storage medium, wherein the communication module is to receive user-submitted metadata describing the related content items; and
a content management module operable on the processor and communicatively coupled to the communication module and the computer-readable storage medium, wherein the content management module is to associate the user-submitted metadata with the primary version in the computer-readable storage medium and to provide a user interface to display the related content items, wherein the user interface comprises a display area to display the primary version and one or more indicators of one or more of the secondary versions.

18. The system of claim 17, wherein the association between the primary version and the user-submitted metadata provides for selection of the primary version using the user-submitted metadata, wherein the secondary versions are not associated with the user-submitted metadata and are not eligible for selection using the metadata.

19. The system of claim 17, wherein the communication module is to receive a search query specifying the user-submitted metadata and is to provide a reference to the primary version and not the one or more secondary versions in response to the query.

20. The system of claim 17, wherein the user-submitted metadata specifies a category of the related content items, and wherein the content management module is to select one or more content items from the corpus in the specified category, wherein the primary version is selected and the one or more secondary versions are not eligible for selection.

21. The system of claim 17, wherein the user-submitted metadata includes a first tag describing the related content items, and wherein the content management module is to select one or more content items from the corpus having the first tag, wherein the primary version is selected and the one or more secondary versions are not eligible for selection.

22. The system of claim 17, wherein the interface includes an input to receive a rating of the primary version, the system further comprising a user management module to receive a user-submitted rating and to incorporate the user-submitted rating of the primary version into a user rating of the submitter of the related content items.

23. The system of claim 22, wherein the one or more indicators of the secondary versions do not include an input to receive a user-submitted rating of the secondary versions.

24. The system of claim 22, wherein the one or more indicators of the secondary versions include respective secondary rating inputs, and wherein ratings submitted via the one or more secondary rating inputs are not incorporated into the user rating of the submitter.

25. The system of claim 17, wherein the one or more indicators of the secondary versions comprise respective links to the secondary versions which, when selected, cause one or more of the secondary versions to be displayed.

26. The system of claim 25, wherein the interface comprises an input to receive a user-submitted rating of the primary version, and wherein the links are not active until a user-submitted rating of the primary version has been submitted.

27. The system of claim 17, wherein the one or more indicators comprise one or more secondary version display areas to display one or more of the secondary versions.

28. The system of claim 27, wherein the interface comprises an input to receive a user-submitted rating of the primary version, and wherein the secondary version display areas do not display the secondary versions until a user-submitted rating of the primary version has been received.

29. The system of claim 27, wherein the secondary version display areas display thumbnail images of one or more of the secondary versions.

30. The system of claim 17, wherein the submitter is permitted to submit only a limited number of content items, and wherein the content management module is configured to include the primary version in the limited number of content items submitted by the submitter and to exclude the secondary versions from the limited number of content items submitted by the submitter.

31. The system of claim 17, wherein a user profile of the submitter identifies representative content items submitted by the submitter, and wherein the content management module is configured to provide for selection of the primary version as a representative content item submitted by the submitter, and is configured to exclude the secondary versions for selection as a representative content item submitted by the submitter.

32. A computer-implemented method for providing secondary versions of a content item submitted by a user to a corpus comprising a plurality of content items, comprising:
designating one of a plurality of related content items as a primary version and the rest of the plurality of content items as secondary versions;
associating the secondary versions with the primary version in the corpus;
receiving user-submitted metadata describing the related content items, the metadata specifying a tag to categorize the related content items;
associating the user-submitted metadata with the primary version in the corpus;
displaying in a user interface a result of a search within the corpus for the specified tag, wherein the interface includes the primary version and does not include the secondary versions.
